(19) United States
(12) Patent Application Publication
(10) Pub. No.: US 2006/0256298 A1
(43) Pub. Date: Nov. 16, 2006

(54) Method and system for displaying a stabilized image by a projector

(75) Inventor: Richard L. Knipe, McKinney, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/129,263

(22) Filed: May 12, 2005

(51) Int. Cl. G03B 21/14

(52) U.S. Cl. 353/69; 353/121

(57) ABSTRACT

According to one embodiment of the invention, a method for displaying an image includes sensing an acceleration of a projector in at least one direction and, based on the sensed acceleration, determining a motion of the projector in at least one direction. The method also includes adjusting an image associated with the projector based on the determined relative motion.

### TECHNICAL FIELD OF THE INVENTION

This invention relates generally to image projection and more particularly to a method and system for displaying a stabilized image by a projector.

### BACKGROUND OF THE INVENTION

Projectors have become commonplace in today's society. For example, projectors are often used for business presentations, such as to display a PowerPoint presentation. Another example use of projectors is in home theaters for displaying movies or television.

One of the problems encountered by projectors is they are susceptible to movement and vibration. Projectors are often mounted on a table top, leaving them susceptible to being bumped. In addition, other sources of movement such as vibration from air conditioning systems and other equipment may cause vibration in the projector. This susceptibility to movement can result in an unacceptably shaky image of the image displayed by the projector.

### SUMMARY

According to one embodiment of the invention, a method for displaying an image includes sensing an acceleration of a projector in at least one direction and, based on the sensed acceleration, determining a motion of the projector in at least one direction. The method also includes adjusting an image associated with the projector based on the determined relative motion.

Embodiments of the invention may provide numerous technical advantages. Some, none, or all embodiments of the invention may benefit from the below-described advantages. For example, according to one embodiment of the invention, an image displayed by a projector may be stabilized. In one embodiment, such stabilization may occur electronically without the need for mechanical gimbals or other such devices. In other embodiments, image adjustment may occur through the use of movable optical devices in response to determination of a movement of a projector through the use of accelerometers. Such a stabilized image provides a more desirable projector.

Other advantages will be readily apparent to one of skill in the art.

### BRIEF DESCRIPTION OF THE FIGURES

For a more complete understanding of the present invention and its advantages, references now made to the following description, taken in conjunction with the accompanying drawings, in which:

FIG. 1 is a schematic diagram illustrating a projector system according to the teachings of the invention;

FIG. 2A is a block diagram of one embodiment of the projector system of FIG. 1;

FIG. 2B is a block diagram of the image adjustment system of the projector system of FIG. 2A;

FIG. 2C is a schematic diagram illustrating one example implementation of the image adjuster of FIG. 3B;

FIG. 3 is a block diagram of an alternative embodiment of a projector system according to the teachings of the invention;

FIG. 4A is a flow chart illustrating example steps associated with a method for displaying a stabilized image according to the teachings of the invention; and

FIG. 4B is a flow chart illustrating example steps associated with the step of adjusting the displayed image of FIG. 4A.

### DETAILED DESCRIPTION OF EXAMPLE EMBODIMENTS

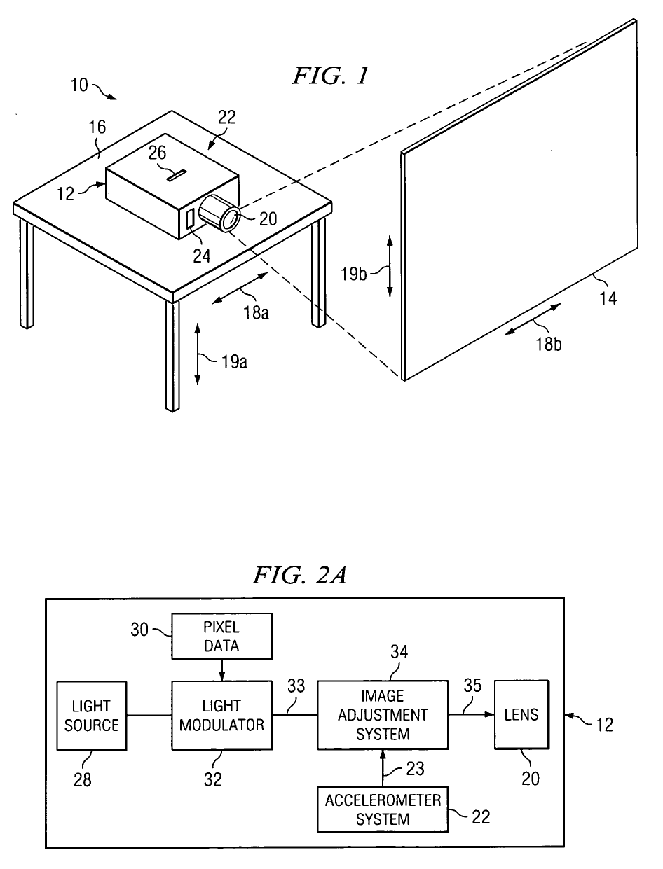

Embodiments of the present invention and its advantages are best understood by referring to FIGS. 1 through 4B of the drawings, like numerals being used for like and corresponding parts of the various drawings.

FIG. 1 is a schematic diagram illustrating a projector system 10 according to the teachings of the invention. Projector system 10 includes a projector 12 for displaying an image 14 through a lens 20. As illustrated, projector 12 is mounted, in this example, on a table 16. The teachings of the invention recognize that table 16 may tend to move or oscillate in response to being bumped or through other means, as indicated by reference numerals 18a and 19a. This movement can result in an image 14 that vibrates or moves, as indicated by reference numerals 19a and 19b. This results in a shaky image 14. The teachings of the invention recognize that such a shaky image can be addressed through measuring the movement of projector and making adjustments such that projected image 14 appears stationary.

According to the teachings of the invention, an accelerometer system 22 is provided on or within projector 12. Accelerometer system 22 may generate a signal indicative of the acceleration of projector 12 in one or more directions, from which the motion, or velocity, of projector 12 in these one or more directions can be obtained. In this example, accelerometer system 22 includes two accelerometers 24 and 26 arranged so as to measure acceleration in directions generally perpendicular to one another; however, it will be understood that accelerometer system 22 may include more or fewer accelerometers as well as accelerometers arranged in different orientations with respect to one another. In the illustrated embodiment, accelerometers 24 and 26 are positioned perpendicular to each other to provide accelerations and directions generally corresponding to the horizontal and vertical directions. Although any suitable accelerometer may be used, example accelerometers include accelerometers available from Analog Devices, Mimcis, and ADXL.

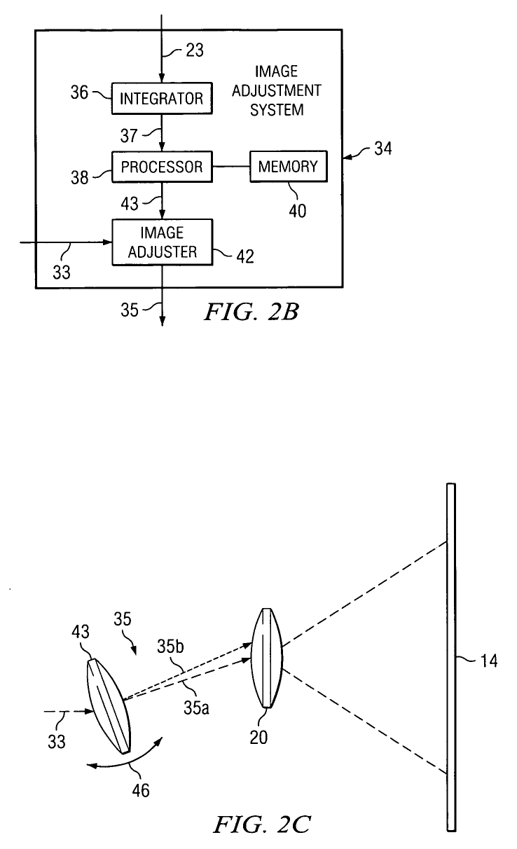

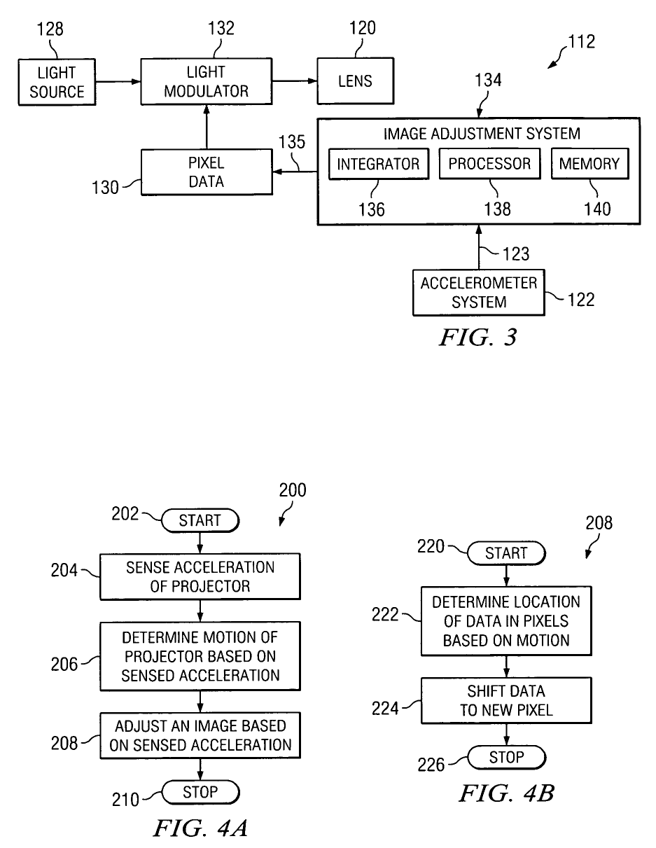

As described in greater detail below, accelerometer system 22 detects accelerations arising from movement of projector 12. This movement may result in response to bumping of table 16 or through other sources of movement, including sources of vibration. In response, an image adjustment system (FIGS. 2A-3) makes adjustments such that image 14 appears stationary. This is effected by shifting an image in directions and velocities generally opposite to the velocity detected of projector 12. The shifted image may be an intermediate light ray within projector 12, the image emanating from lens 16, data corresponding to the projected image, or other image that results in a displayed image 14 that appears stationary. This adjustment may occur optically by positioning a lens or mirror on a gimble and moving the gimble such that the resulting image appears stationary. In another embodiment, displayed image 14 may be made stationary by modifying data representative of stored pixels, as described in greater detail below.

Thus according to the teachings of the invention, by measuring the acceleration of projector 24 in one or more directions, a displayed image 14 may be made to appear stationary even though projector 12 is itself moving. This is accomplished by adjusting an image to have velocities generally opposite that of the projector such that the velocity is canceled, resulting in a stabilized displayed image. Example details associated with example embodiments are described in greater detail below in connection with FIGS. 2A through 4B.

FIG. 2A is a block diagram illustrating example details associated with projector 12, according to one embodiment. Illustrated in FIG. 2A are a light source 28, a spatial light modulator 32, an image adjustment system 34, lens 20, accelerometer system 22, and pixel data 30 stored in a memory. In the illustrated embodiment, light source 28 provides a source of light which is modulated by a spatial light modulator 32. Spatial light modulator 32 may take many forms including LCD, DMD, and LCOS technologies; however, other spatial modulators including those yet to be developed may be utilized. Spatial modulator 32 may include a controller for controlling modulation of received light, which may access pixel data 30, storing data representative of a pixel image to be displayed on image 14. Spatial modulator 32 generates a modulated light signal 33, which is received in this embodiment by image adjustment system 34.

Image adjustment system 34 also receives an adjustment signal 23 from accelerometer system 22. As described above, accelerometer system 22 may include one or more accelerometers such as accelerometers 24 and 26. Image adjustment system 34 may adjust the light signal 33 received from spatial light modulator in response to a determined velocity of projector 22. Additional details of image adjustment system 34 are described in greater detail below in conjunction with FIGS. 2B and 2C. Image adjustment system may produce a modified light signal 35, which is focused and projected to produce displayed image 14. Modified light signal 35 is generated such that it has velocities in directions corresponding to those generally opposite to the determined velocities of projector 12 with magnitudes of velocities that result in a displayed image 14 that appears stationary. In this manner a transient motion, such as a transitory vibration, can be canceled, resulting in a stabilized displayed image 14. It will be understood that, depending on the implementation, the actual magnitudes of the velocities of light signal 35 in directions corresponding to the motion of projector 24 may differ from the actual velocities of the motion of projector 12 in order to create a stabilized image.

FIG. 2B illustrates additional details of one embodiment of image adjustment system 34. In this embodiment, image adjustment system 34 includes an integrator 36, a processor 38, a memory 40, and an image adjuster 42. Integrator 36 may be any suitable hardware or software, or combination thereof, that can receive a signal 23 indicative of the acceleration of projector 24 and integrate that signal to produce a velocity signal 37. Velocity signal 37 is provided to processor 38 and associated memory 40 in which an adjustment for light signal 33 is calculated such that displayed image 14 appears stationary. It will be understood that integrator 36, processor 38, and memory 40 may be integrated into a single unit in some embodiments. In response to the calculation of an adjustment for light signal 33, processor 34 communicates an adjustment signal 43 to image adjuster 42. Image adjuster 42 also receives light signal 33. In response, image adjuster 42 effects a modification of light signal 33 to produce modified light signal 35, with the intention that when light signal 35 is projected by lens 20 the resulting displayed image appears stationary. It will be understood that although the embodiments of FIGS. 2A and 2B illustrate an image adjustment system that modifies a light signal received from modulator 32 that is then projected by lens 20, other embodiments may include an image adjustment system that modifies a light signal projected by lens 20 to accomplish the stabilization of displayed image 14, based on the calculated velocities determined from measured accelerations of projector 12. One example implementation of image adjuster 42 is illustrated in FIG. 2C.

FIG. 2C is a schematic diagram illustrating one example of an image adjuster 42. In this example, image adjuster 42 is a lens mounted to a gimble (not explicitly shown) that receives light signal 33 and adjustment signal 43. In response the lens moves or vibrates in an opposite direction to the motion or vibration of projector 12, as indicated by reference numeral 46, to produce an adjusted light signal 35. Adjusted light signal 35 is illustrated as both light signal 35a and 35b to illustrate the example of a vibrating projector 12. Light signals 35a and 35b are focused and projected by lens 20 resulting in a displayed image 14 that appears stationary. Displayed image 14 appears stationary because light rays 35a and 35b are oscillating in directions directly opposite to projector 12 resulting in cancellation of the vibrations and a stable displayed image 14.

FIG. 3 is a block diagram illustrating an alternative embodiment of a projector 112 according to the teachings of the invention. In this embodiment, projector 112 includes a light source 128, a modulator 132, a lens 120, pixel data 130 stored in memory, an image adjustment system 134, and an accelerometer system 122. In contrast to the projector 12 of FIG. 2A, image adjustment is performed digitally by altering pixel data 130 rather than adjusting the light signal produced by modulator 132, or other light signal. In particular, in this embodiment, image adjustment system 134 receives an acceleration signal 123 from accelerometer system 122 and processes that signal, using an integrator 136, processor 138, and memory 140 to determine the motion of projector 122 and required adjustment to produce a stable image. In contrast to the system of FIG. 2A, image adjustment system 134 produces a signal 135 that alters the arrangement of pixel data 130 stored within memory. The alterations involve adjusting the data stored corresponding to various pixels such that the data are “moved” in a direction and velocity opposite that of projector 12 such that the resulting displayed image appears stationary. The pixel data is modulated by spatial light modulator 132 in any suitable manner and projected by lens 120 to produce a stabilized image. Additional details associated with the embodiment of FIG. 3 are described in greater detail below in conjunction with FIG. 4B.

FIG. 4A is a flow chart illustrating example steps associated with a method 200 for stabilizing an image by a projector. The method begins at step 202. At step 204 the acceleration of a projector is sensed. Such sensing of acceleration may be performed through the use of one or more accelerometers, in a similar manner to that described above in conjunction with FIGS. 1-3. In one embodiment, two accelerometers are used corresponding to the generally horizontal and vertical directions of the image to be displayed. It should also be noted that in one embodiment two accelerometers may be used positioned generally 90° with respect to each other, whether or not they are positioned generally horizontally and vertically.

At step 206, the motion of the projector is determined based on the sensed accelerations. This motion can be determined through the use of an integrator to integrate the sensed acceleration. Any suitable integrator may be used including those implemented in hardware and/or software. At step 208 an image, such as an intermediate image in the projector, is adjusted based on the sensed acceleration to counteract the effects of the motion of the projector such that the displayed image appears stationary. The adjustment of the image may occur in a number of alternative manners including adjusting the image digitally by altering the data corresponding to pixels as well as altering intermediate light rays optically through transmissive, reflective, or through other techniques. One example of such altering is described in greater detail below in conjunction with FIG. 4B. The method concludes at step 210.

FIG. 4B is a flow chart illustrating example steps associated with step 208 of adjusting an image based on the sensed acceleration. In this example, an image is adjusted by altering stored data corresponding to pixels of the image. This method begins at step 220. At step 222 a determination is made of the location of a pixel for which data corresponding to another pixel is to be relocated. This determination can be made by comparing the determined motion of the projector to the stored pixel data to determine where certain pixel data should be moved such that the displayed image would appear stationary. At step 224, the data stored in a particular pixel location is shifted to the new determined pixel location, resulting in a new image that can be displayed and appear stationary because the “movement” of the adjusted image cancels the movement of the projector. The method concludes at step 226.

Thus, according to the teachings of the invention, an image projected by a projector may be stabilized by determining a motion of the projector in one or more directions through an accelerometer system and, in response, an adjustment may be made such that the motion of the projector is cancelled, resulting in a stabilized image.

Although the present invention has been described with several embodiments, a myriad of changes, variations, alterations, transformations, and modifications may be suggested to one skilled in the art, and it is intended that the present invention encompass such changes, variations, alterations, transformations, and modifications as they fall within the scope of the appended claims.

What is claimed is:

1. A method for displaying an image comprising:
sensing, by at least two accelerometers, acceleration of the projector in at least two directions;
based on the sensed accelerations determining the velocity of the projector in first and second directions; and
adjusting an image associated with the projector in directions generally opposite to the first and second directions at velocities generally opposite to the determined velocities in the first and second directions such that the shifted image appears stationary when displayed.

2. A method of claim 1, wherein the at least two directions comprise the first and second directions and the first direction is generally perpendicular to the second direction.

3. A method for displaying an image comprising:
sensing an acceleration of a projector in at least one direction and, based on the sensed acceleration, determining a motion of the projector in at least one direction; and
adjusting an image associated with the projector based on the determined relative motion.

4. The method of claim 3, and further comprising storing data corresponding to respective pixels; and
wherein adjusting an image comprises shifting at least some of the data corresponding to particular ones of the plurality of pixels to particular other ones of the pixels in a direction corresponding to a direction generally opposite of the determined motion such that a resulting image displayed by the projector appears stationary.

5. The method of claim 3, wherein adjusting an image comprises shifting the image in a direction corresponding to a direction generally opposite the determined motion of the projector such that an image displayed by the projector appears stationary.

6. The method of claim 5, wherein shifting an image comprises shifting by one of a reflective optical device and a transmissive optical device.

7. The method of claim 5, wherein shifting an image comprises shifting stored data representative of the image.

8. The method of claim 3, wherein sensing an acceleration of the projector in at least one direction comprises sensing an acceleration by at least one accelerometer.

9. The method of claim 3, wherein sensing an acceleration of the projector in at least one direction comprises sensing the acceleration of the projector in first and second directions, the first direction approximately perpendicular to the second direction.

10. The method of claim 3, wherein determining a motion comprises integrating with respect to time a signal indicative of the sensed acceleration.

11. The method of claim 3, wherein the projector comprises a digital micro-mirror device.

12. The method of claim 3, wherein the projector comprises a plurality of panels of a type selected from the group consisting of LCD and LCOS.

13. The method of claim 3, wherein the projector is a front projection projector.

14. A projector comprising:
a spatial light modulator operable to modulate received light;
a light source operable to generate light to be modulated by the spatial light modulator;
a lens operable to focus light received from the spatial light modulator and project focused light on a display;
at least one accelerometer operable to measure an acceleration of the projector; and
an image adjustment system operable to determine a motion of the projector in at least one direction and effect adjustment of an image associated with the projector in a direction corresponding to a direction generally opposite the determined motion in the at least one direction such that the adjusted image appears stationary when displayed.

15. The projector of claim 14, wherein the adjustment system comprises an integrator operable to integrate a signal indicative of the measured acceleration and determine the motion of the projector therefrom.

16. The projector of claim 14, wherein the adjustment system comprises one of a reflective optical device and a transmissive optical device.

17. The projector of claim 14, wherein the image adjustment system comprises logic encoded in media.

18. The projector of claim 14, wherein the image adjustment system is operable to effect adjustment of the image by shifting data representative of the image.

19. The projector of claim 14, wherein the image adjustment system is operable to effect adjustment of the image by shifting at least some data corresponding to particular ones of a plurality of pixels to particular other ones of the plurality of pixels in a direction corresponding to a direction generally opposite of the determined motion such that an image displayed by the projector appears generally stationary.

20. The projector of claim 14, wherein the spatial light modulator is selected from the group consisting of a DMD light modulator, an LCD light modulator, and an LCOS light modulator.
